(19) United States
(12) Patent Application Publication
(10) Pub. No.: US 2006/0158566 A1
(43) Pub. Date: Jul. 20, 2006

(54) Apparatus and method for projection video display

(76) Inventor: Tooru Sugiyama, Kumagaya-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/317,454

(22) Filed: Dec. 23, 2005

(30) Foreign Application Priority Data
Dec. 27, 2004 (JP) 2004-378184

(51) Int. Cl. H04N 9/73

(52) U.S. Cl. 348/656

(57) ABSTRACT

A projection video display apparatus includes an R light source, a G light source, and a B light source. DMD uses a video signal to modulate a beam generated by each of the R, G, and B light sources. A video beam obtained is projected on to a screen via a projecting optical lens. A control circuit controls driving of R, G, and B by a drive device, in a time division manner, within a unit period which is synchronous with the vertical synchronizing frequency of the video signal, the drive device drivingly turns on and off the light sources independently of one another. In this case, the ratio of irradiation times for R, G, and B is switched within the unit period depending on color temperature.

### CROSS-REFERENCE TO RELATED APPLICATIONS

This application is based upon and claims the benefit of priority from prior Japanese Patent Application No. 2004-378184, filed Dec. 27, 2004, the entire contents of which are incorporated herein by reference.

### BACKGROUND OF THE INVENTION

1. Field of the Invention

The present invention relates to an apparatus and method for projection video display which uses an optical space modulating element such as a digital micromirror device (DMD).

2. Description of the Related Art

Some projection video display apparatuses use a digital micromirror device (DMD) as a space modulating element. Video display devices of this kind conventionally use a lamp as a light source. The recent tendency is to use a light emitting diode (LED) or a light amplification by stimulated emission of radiation (LAZER) as a light source by two-dimensionally arranging them (see, for example, Jpn. Pat. Appln. KOKAI Publication No. 1998-269802).

The above projection video display device is provided with LED light sources corresponding to R, G, and B. Emissions from the light sources are sequentially switched in synchronism with video signals and output to provide a color display. However, RGB switching intervals per unit time are fixed. Accordingly, it is impossible to deal with a variation in or adjustment of color temperature.

Jpn. Pat. Appln. KOKAI Publication No. 2004-37958 describes a projection video display device using a method of adjusting color balance by varying the on duties of R, G, and B per unit time. However, this method assigns the same emission period to each of R, G, and B, and regulates the on period of the color during the assigned period to adjust the color balance. This method makes an on period during the unit period, thus disadvantageously reducing the total quantity of light.

### BRIEF SUMMARY OF THE INVENTION

It is an object of the present invention to provide an apparatus and method for projection video display which, if a color display is provided utilizing an R, G, and B LED light sources, enables color adjustment to be easily accomplished without reducing the total quantity of light.

A projection video display device that is a first characteristic according to the present invention comprises a red (R) light source, a green (G) light source, and a blue (B) light source, an optical element on which a beam generated by each of the R, G, and B light sources is incident and which emits the beam in one direction, an optical space modulating element on which the beam emitted by the optical element is incident and which uses a video signal to modulate the beam and then emits a video beam obtained, a projecting device which projects the video beam emitted by the optical space modulating element, on to a screen via a projecting optical lens, a light emitting element driving device which drivingly turns on and off the R, G, and B light sources independently of one another, and driving control means for sequentially controlling the driving of the R, G, and B light sources by the light emitting element driving device within a unit period in a time division manner, the unit period being synchronous with a vertical synchronizing frequency of the video signal, wherein the driving control means switches the ratio of irradiation times for R, G, and B within the unit period depending on color temperature.

A projection video display device that is a second characteristic according to the present invention comprises a red (R) light source, a green (G) light source, and a blue (B) light source, an optical element on which a beam generated by each of the R, G, and B light sources is incident and which emits the beam in one direction, an optical space modulating element on which the beam emitted by the optical element is incident and which uses a video signal to modulate the beam and then emits a video beam obtained, a projecting device which projects the video beam emitted by the optical space modulating element, on to a screen via a projecting optical lens, a light emitting element driving device which drivingly turns on and off the R, G, and B light sources independently of one another, and driving control means for sequentially controlling the driving of the R, G, and B light sources by the light emitting element driving device within a unit period in a time division manner, the unit period being synchronous with a vertical synchronizing frequency of the video signal, wherein the driving control means inserts a period in which all of the R, G, and B light sources are allowed to emit light or turned off, into the unit period in accordance with brightness adjustment.

A method for projection video display which is a first characteristic of the present invention comprises bundling beams emitted by a red (R) light source, a green (G) light source, and a blue (B) light source so that the bundled beams travel in one direction, using a video signal to subject the beams to optical space modulation, and projecting a resulting video beam on to a screen via a projecting optical lens, and when driving of the R, G, and B light sources by a light emitting element driving device drivingly turning on and off the R, G, and B light sources independently of one another is sequentially controlled, in a time division manner, within a unit period which is synchronous with a vertical synchronizing frequency of the video signal, the ratio of irradiation times for R, G, and B is switched within the unit period depending on color temperature.

A method for projection video display which is a second characteristic of the present invention comprises bundling beams emitted by a red (R) light source, a green (G) light source, and a blue (B) light source so that the bundled beams travel in one direction, using a video signal to subject the beams to optical space modulation, and projecting a resulting video beam on to a screen via a projecting optical lens, and when driving of the R, G, and B light sources by a light emitting element driving device drivingly turning on and off the R, G, and B light sources independently of one another is sequentially controlled, in a time division manner, within a unit period which is synchronous with a vertical synchronizing frequency of the video signal, a period in which all of the R, G, and B light sources are allowed to emit light or turned off is inserted into the unit period in accordance with brightness adjustment.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a projection video display device according to an embodiment of the present invention;

FIG. 2 is a flowchart showing a control procedure for adjustment of color temperature in the device shown in FIG. 1;

FIGS. 3A and 3B are timing charts showing how emission periods are adjusted in accordance with the control procedure shown in FIG. 2;

FIG. 4 is a flowchart showing a control procedure of a brightness adjusting function of the device shown in FIG. 1; and

FIG. 5 is a timing chart showing how emission periods are adjusted in accordance with the control procedure shown in FIG. 4.

### DETAILED DESCRIPTION OF THE INVENTION

An embodiment of the present invention will be described below with reference to the drawings.

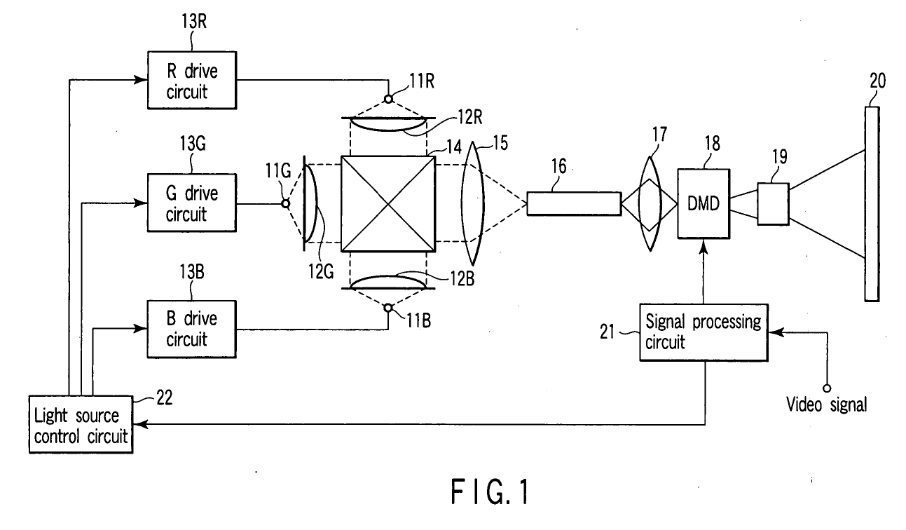

FIG. 1 shows an example of configuration of a projection video display apparatus according to the present invention. Reference numerals 11R, 11G, and 11B denote LED light sources. R, G, and B color filters 12R, 12G, and 12B are installed on light emitting surfaces of the LED light sources 11R, 11G, and 11B, respectively.

The LED light sources 11R, 11G, and 11B are connected to LED driver circuits 13R, 13G, and 13B, respectively. The LED light sources 11R, 11G, and 11B sequentially emit beams at predetermined time intervals in accordance with driving signals from the LED driver circuits 13R, 13G, and 13B, respectively. The LEDs of the light sources 11R, 11G, and 11B are individually turned on and off by the LED driver circuits 13R, 13G, and 13B, respectively.

Beams emitted by the LED light sources 11R, 11G, and 11B are incident on adjacent surfaces of a prism 14 via the color filters 12R, 12G, and 12B, respectively. The beams are then emitted from one irradiation surface and incident on a light tunnel 16 via an optical lens 15. The beams are thus made uniform. The beam having passed through the light tunnel 16 is applied to a video formed surface of a digital micromirror device (referred to as a DMD below) via an optical lens 17.

A large number of micromirrors are arranged in matrix on the video formed surface of DMD 18. The micromirrors individually have their inclinations controlled so that a beam from the light source can be reflected and input to a projection lens system 19 or emitted away from the projection lens system 19. Accordingly, when the large number of micromirrors arranged in matrix each have its reflecting direction determined in accordance with a video signal, a video beam corresponding to the video signal is input to the projection lens system 19. The video beam emitted by the projection lens system 19 is projected on to a screen 20.

A signal processing circuit 21 supplies DMD 18 with video signals corresponding to R, G, and B in a time division manner. A control circuit 22 controls this time division process. Specifically, R, G, and B are sequentially drivingly controlled within a unit period synchronous with the vertical frequencies of the video signals. The control circuit 22 controls the LED driver circuits 13R, 13G, and 13B so that the R, G, and B LED light sources 11R, 11G, and 11B are synchronously lighted in a time division manner in synchronism with time division outputs of video signals by the signal processing circuit 21, the video signals corresponding to R, G, and B. This allows the large number of micromirrors in DMD 18 to output R, G, and B video beams in a time division manner.

In accordance with instructions from the control circuit 22, the LED driver circuits 13R, 13G, and 13B performs time division control of lighting of the LED light sources 11R, 11G, and 11B and controls turn-on and turn-off of the LEDs on the basis of color adjustment. The color adjustment involves an adjustment mode based on color temperature, and a function for increasing brightness.

Description will be given of color adjustment which is made using the above configuration and which is characteristic of the present invention.

With the conventional projection video display apparatus, colors are separated from one another by passing a beam from a white light source through a rotating color wheel. Accordingly, the division ratio of the color wheel determines operation times for R, G, and B. Thus, the operation times cannot be individually controlled. In contrast, the currently primary apparatus can arbitrarily the operation times; the apparatus utilizes LED light sources.

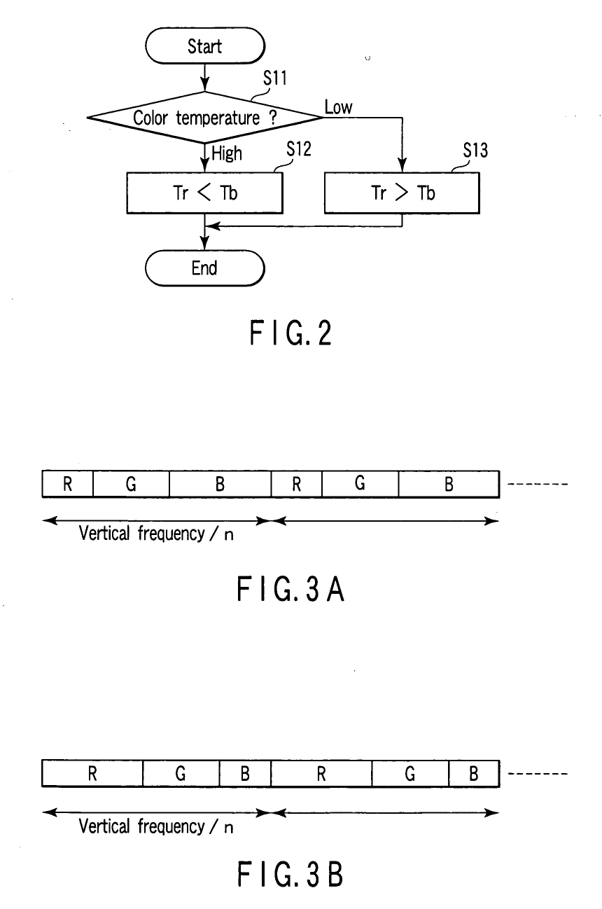

Thus, with the present embodiment, in the adjustment mode based on color temperature, the operation times are adjusted on the basis of the ratio of periods in which the LED light sources are driven. FIG. 2 is a flowchart showing a control procedure executed if a user instructs color temperature to be adjusted using a remote controller (not shown in the drawings) or the like. First, the apparatus determines whether the user has instructed the color temperature to be raised or lowered on the basis of the user's input operation (step S11). If the color temperature is set to a larger value, an emission period Tb for the B light source is kept longer than an emission period Tr for the R light source for a specified period (which is synchronous with the vertical frequency of the video signal) (step S12). This is shown in FIG. 3A. Conversely, if the color temperature is set to a smaller value, the emission period Tr for the R light source is kept longer than the emission period Tb for the B light source for the specified period (step S13). This is shown in FIG. 3B. Although in the above embodiment, description will by given only of the relationship between the emission period of the R light source and that of the B light source, it is advisable to adjust the emission period of the G light source, too, in order to acquire a target color temperature when color adjustment is performed actually.

The above process enables the realization of time division control with the RGB assignment ratio varied depending on the color temperature.

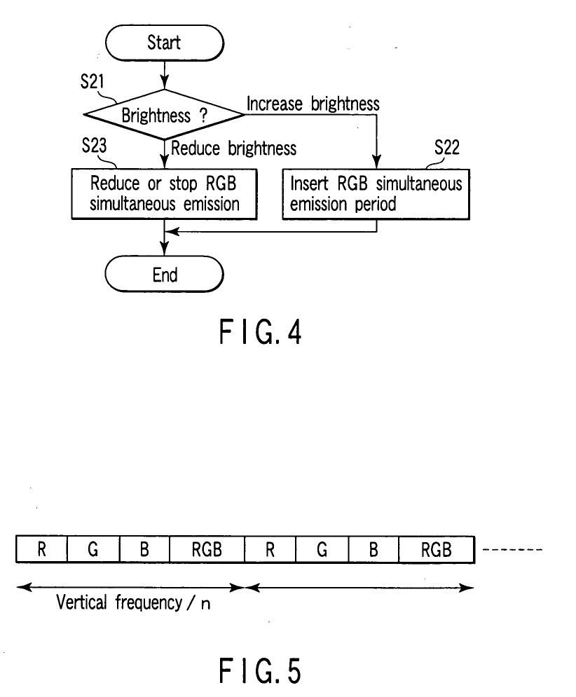

In this case, the user may desire to increase the brightness of the entire screen. FIG. 4 is a flowchart showing a control procedure of a brightness adjusting function that meets such a requirement. First, the apparatus determines whether or not the user has instructed the brightness to be adjusted using the remote controller or the like (step S21). If the user has instructed the brightness of the screen to be increased, then an RGB simultaneous emission period is set within the specified period as shown in, for example, FIG. 5 (step S22). By thus wetting a period in which the R, G and B light sources are simultaneously lighted, the period of white is added to increase the brightness of the entire screen. If the user has instructed the brightness of the screen to be reduced, then the RGB simultaneous emission period is reduced. Alternatively, the period (black period) in which all the R, G and B light sources are kept in the OFF state is employed (step S23). As a result, the brightness of the entire screen is reduced.

The projection video display apparatus configured as described above enables the ratio of irradiation times for R, G, and B to be freely varied within the unit period depending on the color temperature. This enables color adjustment to be easily accomplished without reducing the total quantity of light.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A projection video display device comprising:
a red (R) light source, a green (G) light source, and a blue (B) light source;
an optical element on which a beam generated by each of the R, G, and B light sources is incident and which emits the beam in one direction;
an optical space modulating element on which the beam emitted by the optical element is incident and which uses a video signal to modulate the beam and then emits a video beam obtained;
a projecting device which projects the video beam emitted by the optical space modulating element, on to a screen via a projecting optical lens;
a light emitting element driving device which drivingly turns on and off the R, G, and B light sources independently of one another; and
driving control means for sequentially controlling the driving of the R, G, and B light sources by the light emitting element driving device within a unit period in a time division manner, the unit period being synchronous with a vertical synchronizing frequency of the video signal,
wherein the driving control means switches the ratio of irradiation times for R, G, and B within the unit period depending on color temperature.

2. The projection video display apparatus according to claim 1, wherein the driving control means increases an emission period for the B light source above an emission period for the R light source in order to set the color temperature to a larger value, and increases the emission period for the R light source above the emission period for the B light source in order to set the color temperature to a smaller value.

3. The projection video display apparatus according to claim 1, wherein the driving control means repeatedly switches R, G, and B within the unit period at a speed that is n (an integer equal to or larger than 2) times as high as a normal speed.

4. A projection video display device comprising:
a red (R) light source, a green (G) light source, and a blue (B) light source;
an optical element on which a beam generated by each of the R, G, and B light sources is incident and which emits the beam in one direction;
an optical space modulating element on which the beam emitted by the optical element is incident and which uses a video signal to modulate the beam and then emits a video beam obtained;
a projecting device which projects the video beam emitted by the optical space modulating element, on to a screen via a projecting optical lens;
a light emitting element driving device which drivingly turns on and off the R, G, and B light sources independently of one another; and
driving control means for sequentially controlling the driving of the R, G, and B light sources by the light emitting element driving device within a unit period in a time division manner, the unit period being synchronous with a vertical synchronizing frequency of the video signal,
wherein the driving control means inserts a period in which all of the R, G, and B light sources are allowed to emit light or turned off, into the unit period in accordance with brightness adjustment.

5. A method for projection video display, the method comprising bundling beams emitted by a red (R) light source, a green (G) light source, and a blue (B) light source so that the bundled beams travel in one direction, using a video signal to subject the beams to optical space modulation, and projecting a resulting video beam on to a screen via a projecting optical lens,
wherein when driving of the R, G, and B light sources by a light emitting element driving device drivingly turning on and off the R, G, and B light sources independently of one another is sequentially controlled, in a time division manner, within a unit period which is synchronous with a vertical synchronizing frequency of the video signal, the ratio of irradiation times for R, G, and B is switched within the unit period depending on color temperature.

6. The method for projection video display according to claim 5, wherein an emission period for the B light source is increased above an emission period for the R light source in order to set the color temperature to a larger value, and the emission period for the R light source is increased above the emission period for the B light source in order to set the color temperature to a smaller value.

7. A method for projection video display comprising bundling beams emitted by a red (R) light source, a green (G) light source, and a blue (B) light source so that the bundled beams travel in one direction, using a video signal to subject the beams to optical space modulation, and projecting a resulting video beam on to a screen via a projecting optical lens,
wherein when driving of the R, G, and B light sources by a light emitting element driving device drivingly turning on and off the R, G, and B light sources independently of one another is sequentially controlled, in a time division manner, within a unit period which is synchronous with a vertical synchronizing frequency of the video signal, a period in which all of the R, G, and B light sources are allowed to emit light or turned off is inserted into the unit period in accordance with brightness adjustment.
